(19) United States
(12) Patent Application Publication
(10) Pub. No.: US 2006/0215232 A1
(43) Pub. Date: Sep. 28, 2006

(54) Method and apparatus for processing selected images on image reproduction machines

(76) Inventor: Jakob Ziv-el, Herzliya (IL)

Correspondence Address: Raymond A. Bogucki;#109, 6914 Canby Ave., Reseda, CA, 91335, US

(21) Appl. No.: 11/384,729

(22) Filed: Mar. 20, 2006

Related U.S. Application Data
(60) Provisional application No. 60/664,547, filed on Mar. 23, 2005.

(51) Int. Cl. H04N 1/40

(52) U.S. Cl. 358/448; 358/538

(57) ABSTRACT

A method and apparatus for producing a desired image from an original image on image capturing and processing machines, including copiers, scanners and cameras, comprises designating the part of the image desired with at least one small and uniquely designed indicia element, such as a marked lightly adhesive tab or a marked tile, by placing it on the original image and digitally identifying and processing it according to the design and location of the element. It is shown how such uniquely designed indicia can be used to crop pictures and text from documents including word-to-word cropping, and/or to specify characteristics of the desired image such as resolution, and to determine the rotation or location of the desired images to be produced.

### REFERENCE TO PRIOR APPLICATION

This application relies for priority on provisional application Ser. No. 60/664,547 filed Mar. 23, 2005.

### TECHNICAL FIELD

The present invention relates to known digital image capturing and reproduction machines including copiers, flatbed scanners, handheld scanners, sheet fed scanners, drum scanners and cameras, and the processing of the images captured. In the case of an analogue image capturing machine, the analogue image must first be converted to a digital image before it is processed in a similar way.

### BACKGROUND OF THE INVENTION

There is a need for a functionally efficient method and apparatus for capturing one or more selected images, including text from a document, processing the images according to specific characteristics such as resolution, brightness, size and location, and excluding undesired images, for reasons of clarity or aesthetics, and printing, transmitting or displaying the captured images or further processing them.

Digital copiers and scanners generally rely on the movement of a linear array of electro-optical sensor elements relative to the document whose image is being captured serially. It is not possible to easily capture and reproduce a desired area of a document and exclude undesired parts when the linear array of sensors is wider than the width of the desired image or the relative travel of the sensors is greater than the length of the desired image. For example, this is usually the case when desiring to copy a picture or a paragraph from the center column of a multi-column newspaper. The difficulty of capturing only the desired image is obviously even greater when the image comprises, for example, a few sentences within a paragraph and where the desired text starts at a word within a line and ends before the end of another line.

In the case where there is a two dimensional array of electro-optical sensor elements, such as in a camera, the aspect ratio of the camera sometimes does not match the ratio of width to height of the particular image one wishes to capture, even if one were to use the normal zoom facility. The consequence of these inequalities is the capture of an extraneous image in addition to the image desired. A way of overcoming this problem is described in U.S. Pat. No. 6,463,220 which describes a camera with the addition of a projector for illuminating the field desired.

To avoid capturing the extraneous images in scanners and copiers, sheets of paper may be used for blocking purposes, however these are easily disturbed and clumsy to manipulate. Alternatively in the case of scanners, the image scanned is reproduced on a computer screen and specialized software, such as Adobe®Photoshop®cs2 or Microsoft® Paint, is employed to alter the image. However this involves a relatively lengthy procedure with respect to the number of steps involved, and requires a relatively high degree of computer literacy.

Imperfect images are also produced if the relative movement of the array of electro-optical sensors relative to the document is not at right angles such as when the document is inadvertently placed not squarely on the bed of a scanner or copier, or the document itself is not cut squarely, or when using a handheld scanner the hand movement is at an angle to the ideal direction, or in the case of a camera an accidental misalignment occurs.

Other imperfections that can occur are the shadows or grey areas that surround an image when trying to scan or copy a page from a thick book due to the fold of the book and the visibility of the edges of flaring pages.

In the case of image capturing apparatus without screens or monitors, such as in the majority of copiers, the only recourse to an imperfectly produced image is redo the process with hopefully better results.

Apart from having the simplest and quickest means for correcting imperfections, it is desirable to have available a simple and quick way for specifying the characteristics of the image produced. Such characteristics include resolution, brightness, size, color, location of the image reproduced, and in the case of text the font, indentation of the start of the text reproduced and other characteristics. Currently the method for setting the characteristics is by the use of pushbuttons or carrying out instructions as they appear on a screen. Large numbers of pushbuttons and instructions increase the operator learning time and in some instances the complexity of operation.

### SUMMARY OF THE INVENTION

The method and apparatus of the present invention as applied to digital document copiers, scanners and cameras, requires the placement of one or more uniquely designed indicia with the original image, each indicia element being in the form of a unique pattern appearing on a tab or a tile; next identifying the tab or tile by the pattern design and noting its location and finally processing the image accordingly to produce the desired image. A degree of error in the inclination of the tab or tile must be tolerated, because the placement of these is usually by hand. With a single pattern design on tabs or tiles, different shaped crops of images can be produced, depending on where these are placed.

For example, for cropping a rectangular section of a document using a document copier, generally two tabs, about one square centimeter in size, are placed across the diagonal of the desired rectangle. In the case of one corner of the desired rectangle coinciding with the corner of a rectangular document or in the case of a handheld scanner, one tab may suffice.

In the case of document copiers or scanners lightly adhesive tabs are preferred. “Lightly adhesive” refers for example to the type of adhesion present on the commercial 3M product Post-It™ notes having the trademark Scotch®. The reason for the tabs having to be lightly adhesive is to avoid their shifting due to having to put the document face down on copiers or flatbed scanners, or due to air movement caused for example by the closing of a cover, while at the same time avoiding any serious damage to the document due to adhesion. Where damage is not a consideration, a label or an ink stamp with the indicia pattern can be used.

In the case of using a camera for cropping an image out of a document placed on a horizontal table, tiles about 1 square centimeter in size with a unique indicia pattern design may be placed on the document to accomplish the results mentioned above with respect to lightly adhesive tabs. It is assumed that tiles unlike small pieces of paper are not easily disturbed. Lightly adhesive tabs or such tiles can be referred to as relatively unmovable bodies.

To change the basic parameters of the desired image, such as resolution, brightness or size, a tab or tile with an additional unique pattern design, such as a barcode and/or a keyword which can be read with OCR (optical character recognition) is required to be added.

In the case of extracting a section of text not necessarily within a rectangle, i.e. the section of text does not necessarily start at the beginning of a line or end at the end of a line, the extracted text can be rewritten so it starts at the beginning of a line. If necessary the font can also be changed by virtue of an indicia pattern.

### BRIEF DESCRIPTION OF THE DRAWINGS

FIGS. 1a to 1f show examples of a variety of indicia on different media. FIGS. 1a to 1e show examples of a variety of indicia patterns printed on tabs. FIG. 1f shows an example of a basic pattern design on a tile.

FIGS. 2a and 2b show the placement of tabs on a document in order to crop a particular rectangular area out of the document.

FIG. 3 shows the placement of tabs on a document in order that the desired image of the document appears in a vertical orientation.

FIG. 4a shows the placement of tabs on a document in order to crop a particular circular area out of the document. FIG. 4b shows the circular area cropped as indicated in FIG. 4a.

FIG. 5 shows the placement of tabs on a document in order to crop a particular polygon out of the document.

FIG. 6 shows the placement of tabs on a document in order to crop a particular rectangular area out of the document, and to convert the cropped area to a specified resolution.

FIG. 7a shows the placement of tabs on a document containing text in order to crop a particular portion of text out of the document and reproduce the text such that the start of the reproduced text lines up with the left margin. FIG. 7b shows the reproduced text referred to in FIG. 7a. FIG. 7c shows the placement of additional tabs to those in FIG. 7a using an alternative method for margin recognition.

FIG. 8a shows a side view of a document placed on a horizontal table being photographed by a camera, with tiles placed on top of the document to indicate the exact area within the document that one wishes to reproduce in the photograph. FIG. 8b shows the plan view of the placing of tiles on a document in order to produce a photograph of a particular rectangular area within the document.

FIG. 9a shows the stages of an algorithm used to recognize indicia and implement one embodiment of the invention. FIG. 9b shows three stages within the preprocessing stage in FIG. 9a

FIG. 10 shows an edge map of the indicia pattern shown in FIG. 1a.

FIG. 11 shows the edge map of FIG. 10 after application of a low pass filter.

FIG. 12 shows the principal components of a system to implement the invention.

### DETAILED DESCRIPTION

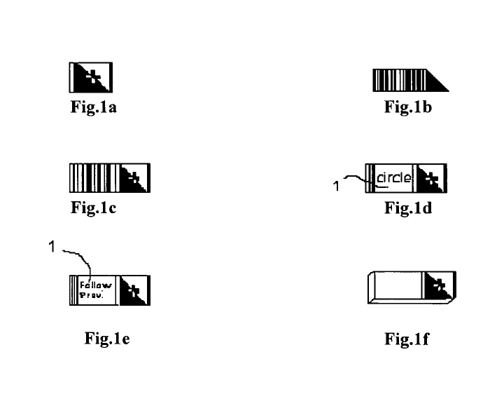

FIG. 1a represents an example of a basic indicia pattern design placed on a lightly adhesive tab.

FIG. 1b represents an example of an alternative basic pattern design placed on a lightly adhesive tab. The advantage of the basic pattern design of FIG. 1a over that of FIG. 1b is speed of recognition due to the use of the principle of inverse indicia as will be explained.

FIGS. 1c, 1d and 1e are examples of lightly adhesive tabs having the basic pattern design of FIG. 1a, and with additional information in the form of a barcode. The barcode may be used to indicate that OCR and word processing should be activated.

FIGS. 1d and 1e are examples of lightly adhesive tabs with further additional information in the form of text, 1. The text serves to identify the tab type visually. If OCR is available it can also serve as an instruction to the machine on the desired output.

FIG. 1d shows the word “circle” and is used to instruct the machine that the area to be cropped is a circle.

FIG. 1e shows the words “Follow Prev.” and is used to instruct the machine that the current and following visual image being copied or scanned are to be assembled such that they appear together on the same document, one immediately following the other. There are two benefits to be gained from this procedure. Firstly less paper is used in the production of the document, if the image comprises for example small sections of text. Secondly, if the image to be copied or scanned is for example a picture or drawing which is larger than can be accommodated on a flatbed scanner, it enables individual sections of the picture or drawing to be scanned and successively assembled in memory for reproduction on a printer which can handle large documents.

FIG. 1f represents an example of the basic pattern design of FIG. 1a, placed on a tile.

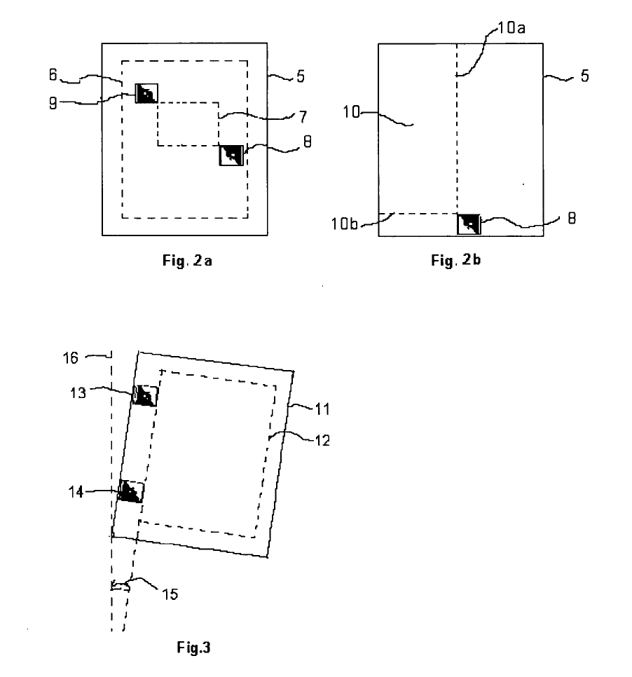

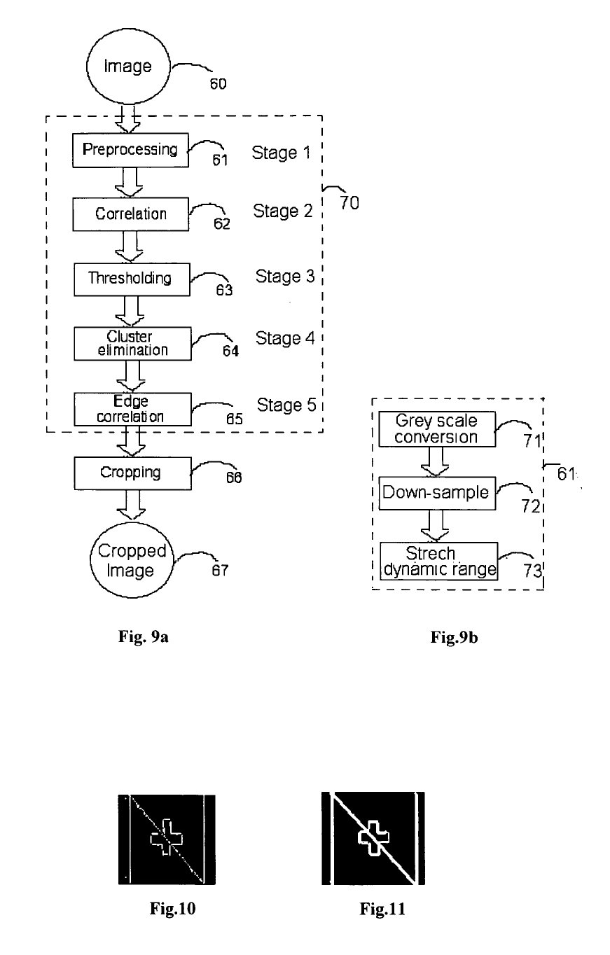

FIG. 2a shows the placement of lightly adhesive tabs 9 and 8 on a document 5 with margins 6, in order to crop a particular rectangular area 7 out of the document 5. Tab 8 is rotated 180 degrees with respect to tab 9 and these two tabs define the diagonal of the rectangle 7. An algorithm used to recognize the patterns on the two tabs 9 and 8 and thereby implement the required action is explained with reference to FIG. 9.

FIG. 2b shows the placement of a lightly adhesive tab 8 on a document 5 in the same 180 degree orientation that tab 8 appears in FIG. 2a. Here too it defines the bottom right hand corner of a rectangle. Thus in the absence of any other tab, the two sides of the rectangle 10 to be cropped are the vertical and horizontal lines 10a and 10b which meet at tab 8, while the other two sides of rectangle 10 coincide with the edge of the document 5 as shown.

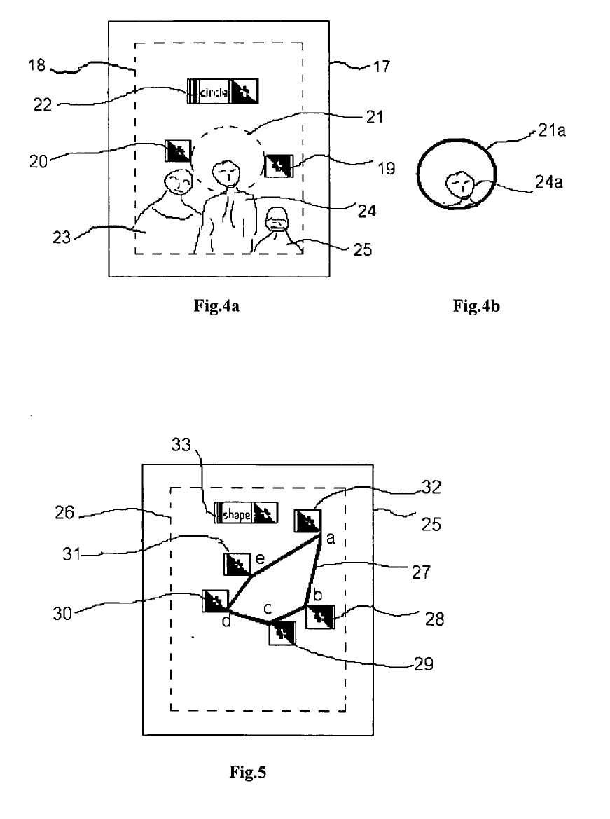

FIG. 3 shows a document 11 placed at an angle 15 relative to the direction 16 of the sweep of the scanning head of a copier or scanner, or the vertical position 16 of a camera. It is normally reproduced at an angle 15 from the vertical line 16. However by placing tabs 13 and 14 on the document 11 next to the left hand side of margin 12 at approximately the same angular orientation with respect to each other as shown, the image of the document will be reproduced in the desired vertical orientation instead of at the angle 15. To implement it, use is made of the algorithm for tab pattern recognition explained with reference to FIG. 9 and the angular variation permitted, explained with reference to FIG. 11.

FIG. 4a shows the placement of tabs 19, 20 and 22 on a document 17 which shows three persons 23, 24 and 25 for cropping a particular circular area 21 out of the document 17, which has margins 18. Tab 19 is rotated 180 degrees with respect to tab 20 and both define the diameter of the circle. Tab 22, which is also explained with reference to FIG. 1d, confirms that it is a circle by virtue of the barcode on the left hand side of tab 22 and/or if OCR is present by virtue of the word “circle”. The recognition of the basic pattern design on tabs 20, 19, and 22, is done through the use of the algorithm explained with reference to FIG. 9. The programming instructions for producing a cropped circle, is well known to those skilled in the art of image processing. See for example the commercial program Adobe®Photoshop®cs2.

FIG. 4b shows the cropped circular area indicated in FIG. 4a.

FIG. 5 shows the placement of tabs on a document 25 with margins 26 in order to crop a particular shaped polygon abcde, out of the document. Tabs 28,29,30,31 and 32 define the shape to be cropped. Tab 33, analogous to tab 22 in FIG. 4a, confirms that it is a polygon by the barcode on the left hand side of tab 33 and/or if OCR is present by virtue of the word “shape”. The recognition of the basic pattern design on tabs 28,29,30,31, 32 and 33, is done through the use of the algorithm explained with reference to FIG. 9. The programming instructions for connecting the straight lines of the particular shaped polygon abcde and for the cropping of a polygon is well known to those skilled in the art of image processing. See for example commercial programs Adobe®Photoshop®cs2 and Microsoft® Paint.

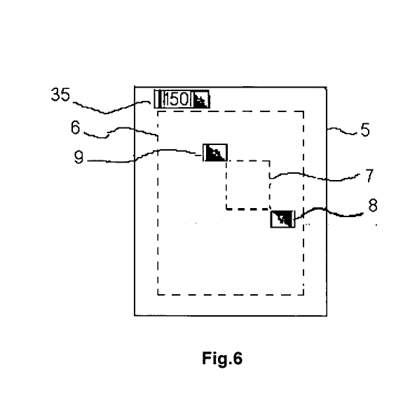

FIG. 6 is similar to FIG. 2, for cropping a particular rectangular area 7 out of the document except that a tab 35 is added to specify the resolution of the cropped area. Tab 35 states both by the barcode on the left hand side of tab 35 and by the printed number “150” if OCR is present, (analogous to specification on the tabs in FIGS. 1d and 1e) that the resolution is 150 dpi (dots per inch). The cropping is accomplished in the same way as explained with reference to FIG. 2, and then the resolution of the resulting cropped image is changed in a manner well known to those in the field of image processing. See the commercial program Adobe®Photoshop®cs2.

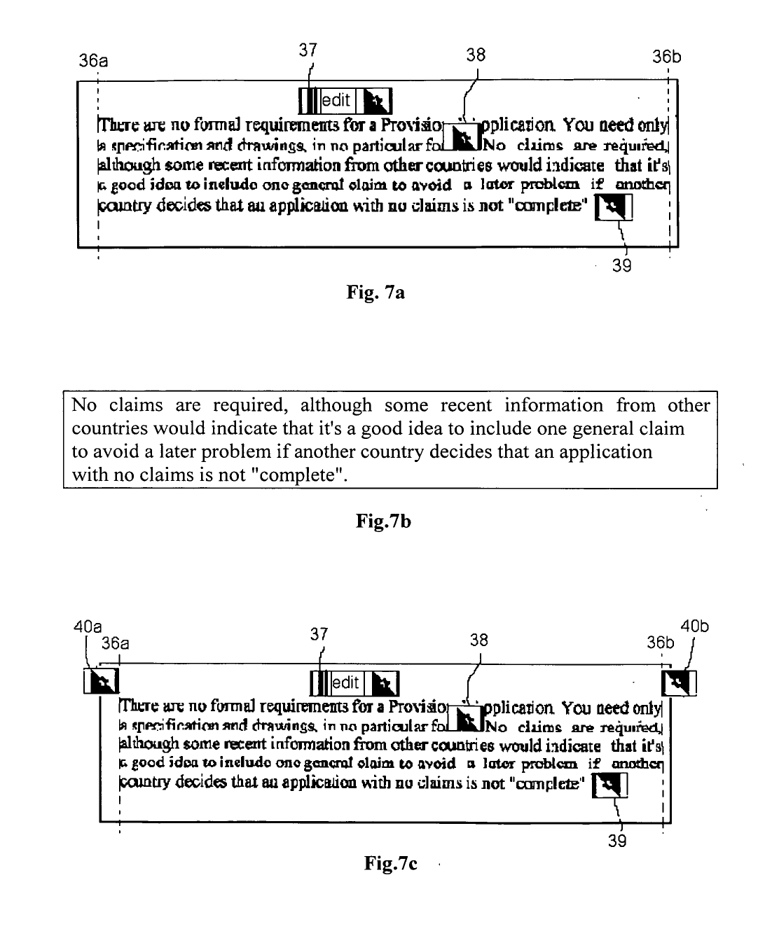

FIG. 7a shows the placement of tabs 38 and 39 on a document containing text in order to crop a particular section of the text out of the document. The additional tab 37 states, analogous to specification on the tabs in FIG. 1d and 1e, that OCR must be activated and furthermore that the text must be reedited such that the start of the reproduced text must line up with the left margin. This is indicated both by the barcode on the left hand side of tab 37 and by the printed word “edit”. The recognition of the basic pattern design on tabs 37, 38 and 39, is done through the use of the algorithm explained with reference to FIG. 9. The reediting of text as specified is well known to those skilled in the art of word processing.

The margins 36a and 36b can be recognized by algorithms such as quoted in U.S. Pat. No. 6,463,220. The alternative is to place an additional two tabs, 40a and 40b, to designate the margins 36a and 36b respectively as shown in FIG. 7c.

FIG. 7b shows the reproduced text referred to in FIGS. 7a and 7c.

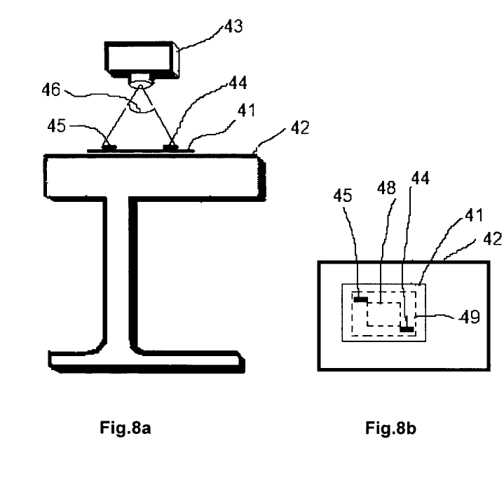

FIG. 8a shows a side view of a document 41 placed on a horizontal table 42 being photographed by a camera 43 and FIG. 8b shows the top view. Tiles 45 and 44, described with reference to FIG. 1f, are placed on top of the document 41 to indicate the rectangular area 48 on the document 41 that must be reproduced in the photograph, analogous to the placing of the lightly adhesive tabs 9 and 8 in FIG. 2a.

Tiles can also be placed in other configurations analogous to the placing of tabs in FIGS. 4 to 7.

Generally in copiers and scanners, the distance of the electro-optical sensors relative to the part of the image of the document being read, is constant. Using a camera however, the distance of the camera to the document varies. Accordingly the image processor within the camera must take into account the apparent change in size of the indicia pattern, by a change of scale according to the distance from the camera and the zooming factor if a zoom facility is used. Automatic infrared distance measurement apparatus is known and its output is fed into the image processor.

In operation, using the camera screen display, the zoom facility is used so that the desired area is framed on the display including the tiles 45 and 44. In FIG. 8b it is the rectangle 49. Zooming in to this extent is most desirable for best recognition of the indicia on tiles 45 and 44 and for operation of OCR where the application is analogous to FIG. 7.

The recognition of the basic pattern design on tiles 44 and 45 is done through the algorithm explained with reference to FIG. 9.

FIG. 9a shows five stages, 61 to 65 within block 70, of an algorithm used to recognize and locate the uniquely designed basic indicia pattern, such as FIG. 1a, on a tab or tile, appearing with an original visual image 60, whether captured into electronic memory by copier, scanner or camera, so that by memory scanning or serially inspecting the electronic memory the image can be processed according to the positioning of the indicia and/or according to any coded or text instructions appearing with the indicia. When using the indicia shown in FIG. 1, some angular inclination of the indicia must be tolerated since these are invariably placed by hand and also speed of execution is important. Processing can often start while the image is being captured.

After locating the uniquely designed indicia pattern, any further encoding such as the barcodes or text in FIGS. 1c to 1e can be located, since these are located in the same position relative to the basic indicia pattern, and the related instructions can be executed.

FIG. 9a also shows an additional stage 66 for the particular case where it is used to produce the cropped image 67. This corresponds to rectangle 7, as described with reference to FIG. 2a, where a set of two indicia 9 and 8 are used.

It is obvious that the more details in the design of the indicia in terms of color and shape, the more unique is its design, however the more processing is needed and the longer it takes to identify an indicia element in a given surroundings. A practical compromise between uniqueness and processing time is by the use of an indicia pattern in black and white such as in FIG. 1a. Furthermore, where two indicia patterns are required, a faster and a more efficient implementation is provided when using inverse indicia patterns as will be described. Thus in the depicted configuration in FIG. 2a, the two indicia form a pair of inverse images, i.e. each image which when rotated through 180 degrees results in the inverse of the image, i.e. black areas are shown white and white areas are shown black.

If an indicia pattern in black and white is used then the image on which it is placed can also be simplified by eliminating some color details. This process will be referred to as part of “normalization” in stage 1 of FIG. 9a. In this regard it is noted that in day to day practice color is described in RGB (Red, Green, Blue) or HSV (Hue, Saturation, Value) representations and simplification can be achieved through the elimination of the hue and saturation components.

The five stages of the algorithm of FIG. 9a plus the additional stage are Preprocessing 61, Correlation 62, Thresholding 63, Cluster elimination 64, Edge correlation 65 and Cropping 66. The algorithm is designed to simultaneously detect both an indicia pattern and its inverse, and these can also be referred to as the “positive” and the “negative” indicia elements. If non-inverse indicia are used, two executions of the algorithm have to be applied, detecting in each execution only a single “positive” indicia element, thereby slowing the process.

It is assumed here that the intensity values of a single-channel image are within the range of [0,1], where 0 represents black and 1 represents white. Other intensity ranges (typically [0,255]) are equally applicable, as these can be normalized to the range of [0,1] through division by the high value of white.

Stage 1—Preprocessing, 61. The acquired input image is preprocessed to a “normalized” form, eliminating unneeded features and enhancing the significant details. This comprises three stages as shown in FIG. 9b. First, color information (if present) is discarded, transforming the image to single-channel grayscale mode, 71 in FIG. 9b. For a 3-channel RGB image, this can be done by eliminating the hue and saturation components in its HSV representation. For information on HSV and grayscale conversion see Gonzalez, R. C, Woods, R. E and Eddins, S. E (2004) Digital Image Processing (Pearson Prentice Hall, NJ) pp. 205-206 The image is then down-sampled to say 100 dpi resolution, 72 in FIG. 9b. The reduced resolution implies less detail and leads to shorter running times of the algorithm, however the amount of down-sampling possible is dictated by the size of the fine details in the indicia's pattern in FIG. 1a. Further down-sampling is possible if less fine detail is to be detected in the indicia, however this tends to detract from the uniqueness of the pattern. Finally, the contrast of the input image is enhanced by stretching its dynamic range within the [0,1] range, 73 in FIG. 9b, which may cause a small percentile of intensity values to saturate on the extremes of this range. For contrast stretching see Pratt, W. K (2001) Digital Image Processing, 3rd ed. (John Wiley & Sons, NY) p. 245. This step is intended to increase the significance of the correlation values in the next stage, Stage 2.

Stage 2—Correlation (or shape matching), 62. The uniquely designed indicia element shown in FIG. 1a, utilizes two colors, black and white. This indicia element can therefore be described as a binary (or black and white) image. In its 100 dpi-resolution representation (or more generally, the same resolution as the normalized image obtained in Stage 1), it will be referred to as the indicia kernel. For correlation see Kwakernaak, H. and Sivan, R. (1991) Modern Signals and Systems (Prentice Hall Int.), p. 62.

In this Stage 2, a correlation operation is carried out between the indicia kernel and the normalized image of Stage 1. Before the actual correlation, the intensity values of both the normalized input image and the indicia kernel are linearly transformed from the [0,1] range to the [−1,1] range, by applying the transform Y(X)=2X−1 to the intensity values. Following this transform, the two are correlated. Assuming the indicia kernel contains K pixels, then the correlation values at every location will vary from −K to +K, +K representing perfect correlation, −K representing perfect inverse correlation (i.e. perfect correlation with the inverse pattern), and 0 representing absolutely no correlation. Therefore, if one indicia element is defined as the negative of its pair, then both can be detected virtually simultaneously by examining both the highest and the lowest correlation values. This leads to significant performance gains, as the correlation stage is the most time consuming component of the algorithm. Next, the correlation values which initially span a range of [−K,+K], are linearly scaled to the normalized range of [0 . . . 1] for the next stage, using the transform Z(X)=(X+K)/2K.

Stage 3—Thresholding, 63. In this stage the correlation values calculated in Stage 2 are thresholded, forming two sets of candidate positions for the locations of the two indicia. The set of highest correlation values, such as those between 0.7 to 1.0, are designated as candidates for the location of the positive indicia element, and similarly the set of lowest correlation values, such as those between 0.0 and 0.3, are designated as candidates for the location of the negative indicia element (if a negative indicia element is indeed to be detected).

The need to establish a set of candidate positions for each indicia element, as opposed to simply designating the highest and lowest correlation values as their true locations, arises because in practice the extreme correlation values may not necessarily indicate the actual positions of the two indicia. Several intervening factors such as noise, slight inclination of the indicia element, slight variation in size or use of reduced-contrast tabs etc. can all negatively effect the correlation values at the true indicia locations, promoting other (false) locations to occupy the extreme points. The next stages are therefore intended to detect and eliminate these “false alarms” of high correlation values, leaving only the true locations of the indicia in place.

Stage 4—Cluster elimination, 64. An effect seen in practice is that around every image position which correlates well with the indicia kernel, several close-by positions will correlate well too, thereby producing “clusters” of high correlation values. (By “close-by” is meant distances which are small relative to the size of an indicia element). It can be assumed for the degree of accuracy required that highly-correlated positions which are very close to each other relative to the size of an indicia element all correspond to the occurrence of the same indicia element. Therefore one can select a single representative value from each such cluster—the best one—and discard the rest of the cluster.

To do this, first the candidates for selection are ordered by their correlation values, such that the candidates with values in the range 0.0 to 0.3 are in ascendant order and those in the 0.7 to 1.0 range are in descendant order. Next, one iterates through the ordered candidates, and checks for each one if there exist other, less-well correlated candidates for the same indicia kernel, in a circular area of fixed radius about it, as stated below. If so, all these candidates are eliminated and removed from the list. The process continues with the next best correlated candidate in the list (among all those which have not yet been eliminated from it). A practical radius of the circular area is 30% the length of the tab's shorter edge. Finally, one gets a short list of candidates for each indicia element.

Alternative methods for the cluster elimination process can also be utilized.

Stage 5—Edge correlation, 65. Due to several reasons (such as those mentioned in Stage 3), one may obtain “false alarms” about reasonably correlated positions which do not correspond to an actual indicia element. To eliminate such errors, edge correlation is adopted to determine the true indicia locations.

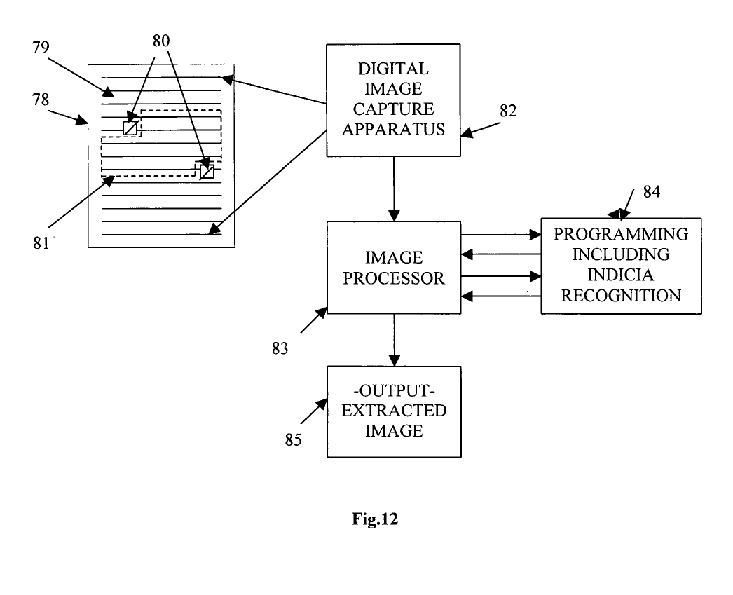

First, the edge map of the indicia pattern is generated, as shown in FIG. 10, using some edge-detection algorithm such as the Sobel or Canny methods. For edge-detection see Gonzalez, et al (2004) Digital Image Processing (Pearson Prentice Hall, NJ) pp. 384-393. To tolerate some inclination of the tab, a low-pass filter (Gaussian filter or any other) is applied to the indicia edge map, resulting in a blur of the edge map as shown in FIG. 11. The blurred edge-map is thresholded, such that its pixels are mapped to binary black and white values; for instance, those above 0.2 are mapped to 1, and the remaining ones are mapped to 0.

Next, for each candidate position remaining after Stage 4, one extracts from the normalized image the segment area which is the same size as an indicia element, and which possibly contains the image of the indicia element in the input image. The edge maps of all segments are calculated, and these are correlated with the blurred and threshholded indicia edge map, The segment showing the best correlation is selected as the true indicia element location, provided that this correlation value exceeds some minimum value X (X can be selected as some percentile of the number of white pixels in the blurred, thresholded edge-map of the indicia.). This minimum value ensures that if no indicia element exists in the input image then the method does not return any result. Also, by altering the value of X one can control the amount of inclination of the tab that the method will accept—higher values of X correspond to less tolerance to inclination, i.e. it will accept only smaller inclinations.

Stage 6—Cropping, 65. Once the locations of the indicia are resolved in the normalized image, the source image can be cropped accordingly. Since the horizontal and vertical directions of a digitized image are known, the locations of the two indicia uniquely define the cropping rectangle.

If the source image had a resolution higher than 100 dpi, then it was down-sampled at the preprocessing stage 1. In this case, each one of the 4 positions in the low-resolution normalized image designating a corner of the cropping region, maps to a square region of several positions in the high-resolution image. To resolve the ambiguity, the central position of each such region is selected, producing 4 cropping points in the original high-resolution input image. The choice of the central point minimizes the error introduced in the cropping region due to the translation from low- to high-resolution. Finally, the image of FIG. 2a is cropped according to the 4 cropping corners, as stated in block 67 in FIG. 9.

Typically an indicia element that is inclined up to 20 degrees can be detected in the correlation operation of Stage 2, whereas an inclination up to 10 degrees can be detected in the edge correlation operation of Stage 5. Thus, referring to FIG. 3, where the inclination of tabs 13 and 14 correspond to the inclination of the document 11, the tabs can be detected provided the inclination angle 15 of the document does not exceed 10 degrees. The programming instructions for rotating an image anti-clockwise to remove an inclination such as in FIG. 3, is well known to those skilled in the art of image processing. See for example the commercial program Adobe®Photoshop®cs2.

Another algorithm that can be used for finding indicia, such as shown in FIG. 1, is the Hough Algorithm (or Hough Transform). The Hough transform can be regarded as a generalized template matching method for pattern recognition based on majority-voting, as is known to those skilled in the art. The Hough transform is typically used to extract edges, curves and other fixed shapes from an image. In the present invention, one may use successive applications of the transform to detect the various components of the indicia pattern independently.

FIG. 12 shows the components of a generalized system for implementing the invention. In FIG. 2 indicia 80, are placed on image 79 on document 78, in order to output the desired image 81. The image 79 plus indicia, 80, are captured by the digital image capturing apparatus 82, which is either a scanner, or a copier or a camera.

By a scanner is implied a flatbed scanner, handheld scanner, sheet fed scanner, or drum scanner. The first three allow the document to remain flat but differ mainly in whether the scan head moves or the document moves and whether the movement is by hand or mechanically. With drum scanners the document is mounted on a glass cylinder and the sensor is at the center of the cylinder. A digital copier differs from a scanner in that the output of the scanner is a file containing an image which can be displayed on a monitor and further modified, whereas the output of a copier is a document which is a copy of the original, with possible modifications in aspects such as color, resolution and magnification, resulting from pushbuttons actuated before copying starts.

The capturing apparatus 82 in the case of a scanner or copier usually includes a glass plate, cover, lamp, lens, filters, mirrors, stepper motor, stabilizer bar and belt, and capturing electronics which includes a CCD (Charge Coupled Device) array.

The image processor 83 in FIG. 12 includes the software that assembles the three filtered images into a single full-color image in the case of a three pass scanning system. Alternatively the three parts of the CCD array are combined into a single full-color image in the case of a single pass system. An alternative to the Capturing Electronics 82 being based on CCD technology, CIS. (Contact Image Sensor) technology can be used. In some scanners the Image Processor 83 can software enhance the perceived resolution through interpolation. Also the Image Processor 83 may perform processing to select the best possible choice bit depth output when bit depths of 30 to 36 bits are available.

The indicia detection and recognition software 84 in FIG. 12 includes instructions for the algorithm, described with reference to block 70 in FIG. 9a, to recognize uniquely designed indicia. It also includes the instructions for the various functionalities as described with reference to FIGS. 2 to 7 in order to output the desired image 81.

The Output 85 in FIG. 12 in the case of a scanner is a file defining desired image 81, and is typically available at a Parallel Port; or a SCSI (Small Computer System Interface) connector; or a USB (Universal Serial Bus) port or a Firewire. The Output 85 in the case of a copier is a copy of the original document as mentioned above.

In the case of a digital camera the capturing apparatus 82 in FIG. 12 includes lenses, filters, aperture control and shutter speed control mechanisms, beam splitters, and zooming and focusing mechanisms and a two dimensional array of CCD or of CMOS (Complementary Metal Oxide Semiconductor) image sensors.

The image processor 83 for cameras interpolates the data from the different pixels to create natural color. It assembles the file format such as TIFF (uncompressed) or JPEG (compressed). The image processor 83 may be viewed as part of a computer program that also enables automatic focusing, digital zoom and the use of light readings to control the aperture and to set the shutter speed.

The indicia detection and recognition software 84 for cameras is the same as that described for scanners and copiers above, with the additional requirement that the apparent change in size of the indicia pattern due to the distance of the camera from the document and the zooming factor, should be taken into account as explained with respect to FIG. 8.

The Output 85 in FIG. 12 in the case of a digital camera is a file defining desired image 81 and is made available via the same ports as mentioned with respect to scanners, however in some models removable storage devices such as Memory Sticks may also be used to store this output file.

### REFERENCES CITED

### U.S. Patent Documents

U.S. Pat. No. 6,463,220, October, 2002, Dance et al 396/431

### Commercial Software

Adobe®Photoshop®cs2
Microsoft® Paint

### Other References

Gonzalez, R. C, Woods, R. E and Eddins, S. E (2004) Digital Image Processing (Pearson Prentice Hall, NJ) pp. 205-206 and pp. 384-393
Pratt, W. K (2001) Digital Image Processing, 3rd ed. (John Wiley & Sons, NY) p. 245
Kwakernaak, H. and Sivan, R. (1991) Modern Signals and Systems (Prentice Hall Int.), p. 62.

What is claimed is:

1. The method for deriving an image from an image bearing document comprising the steps of:
placing relatively small machine identifiable encoded indicia on the document in at least one location;
recording the document image;
identifying the indicia, and
deriving the desired image using the identifiable indicia.

2. The method of claim 1, where the positioning of the indicia designate an image to be cropped.

3. The method of claim 1, where image processing instructions derive from the code on the encoded indicia.

4. The method of claim 1, where the recording of the document image is accomplished through scanning the document image including the indicia.

5. The method of claim 1, where the recording of the document image is accomplished through photographing the document image including the indicia.

6. The method of claim 1, where at least a section of the encoded indicia comprises an image which when rotated through 180 degrees results in the inverse of the image.

7. The method of claim 1, where the indicia comprise relatively unmovable bodies.

8. The method of claim 1, where the positioning of the indicia designate the degree of rotation of the image of the document.

9. The method of claim 1, where an encoded indicia element designates characteristics of the image to be produced.

10. The method of claim 1, where an encoded indicia element designates the manner of assembly of the derived image with the one to follow.

11. The method of claim 1, where an encoded indicia element designates the activation of optical character recognition and word processing for reproduction of text.

12. A method for identifying encoding on indicia-bearing elements containing instructions for excerpting portions of a document as it is being scanned, comprising the steps of:
normalizing the original image including an indicia-bearing element thereon;
obtaining correlation values between the indicia image and the normalized image;
identifying the indicia in accordance with the correlation values, and
identifying the instructions associated with the indicia.

13. The method as set forth in claim 12, and including the further steps of:
thresholding the correlation values;
providing clusters of high correlation values for individual indicia elements;
choosing a single representative value from each cluster, and
carrying out an edge correlation to select the best representative value.

14. The method as set forth in claim 13, further including the steps of storing image information as to the document being scanned, and using the instructions provided by the best representative values.

15. A system for deriving a selected image from an image-bearing basic document, comprising:
at least one indicia member placed on the document and bearing instructions for production of the image to be derived;
an image reproduction machine for scanning the image, including the at least one indicia member, on the document;
a memory apparatus responsive to the scanner for retaining data as to the image on the document; and
a data processor responsive to signals representing the recorded image and the at least one indicia member for deriving the selected image from the document.

16. A system as set forth in claim 15, wherein the system further includes data output means responsive to the data processor for presenting the derived image.

17. A system as set forth in claim 15, wherein the instructions for the derivation of the selected image are based on the positioning of the at least one indicia member.

18. The system of claim 15, where the instructions for the derivation of the selected image are based on encoded instructions on the at least one indicia member.

19. A system as set forth in claim 15, wherein the data processor includes a program control for recognizing instructions contained in the at least one indicia member, for deriving the selected image.

20. A system as set forth in claim 15, wherein the at least one indicia member includes instructions in alpha numeric form and the program control includes an optical character recognition means for reading the alpha numeric instructions.

21. A system as set forth in claim 15, wherein the indicia member is removably retained on the document and in size comprises a small fraction of the image on the document.

22. A system for producing an extracted image of a portion of a document in accordance with instructions contained in indicia selectively placed on the document, comprising:
a scanning system for providing a digital record of the document, including the indicia;
a data processing system receiving the digital record and identifying the instructions, the processing system including programming means for extracting that part of the image defined by the instructions, and
an output device responsive to the data processing system for presenting the extracted image.
